(19) United States
(12) Patent Application Publication
(10) Pub. No.: US 2016/0058657 A1
(43) Pub. Date: Mar. 3, 2016

(54) FLEXIBLE WEARABLE DEVICES HAVING EMBEDDED ACTUATORS PROVIDING MOTION STIMULATIONS

(71) Applicants: Cornell University, Ithaca, NY (US); Medingen Group LLC, Rochester, NY (US)

(72) Inventors: Amit Lal, Ithaca, NY (US); Huiju Park, Ithaca, NY (US); Hadi Hosseinzadegan, Ithaca, NY (US); Manoj Pandy, Ithaca, NY (US); Marina Gaeta, Ithaca, NY (US); Eric Beaudette, Ithaca, NY (US); Mary Maida, Canandaigua, NY (US)

(21) Appl. No.: 14/473,787

(22) Filed: Aug. 29, 2014

(51) Int. Cl. A61H 23/02; A41D 1/02; A42B 1/00; A41D 19/00; A41D 1/00; A41D 1/04; A41D 1/06

(52) U.S. Cl. CPC A61H 23/0263; A41D 1/04; A41D 1/02; A41D 1/06; A41D 19/00; A41D 1/00; A42B 1/006; A61H 23/0245; A61H 2023/0272

(57) ABSTRACT

Methods, systems, and devices are disclosed for applying motion stimulations on a body using actuators. In one aspect, a device to provide mechanical stimulation to a user includes an apparel material capable of being worn by a user, a flexible material substrate configured at a portion or region of the apparel material, an actuator module attached to the flexible material substrate and structured to include an array of piezoelectric actuators to apply mechanical perturbations at a frequency to the user wearing the apparel material, and a power supply module electrically coupled to the actuator module to provide electrical power to the actuator module. The actuator module may be located within one of a pillow, seat, bed and stuffed animal, or it may be in physical connection with one of wearable apparel, bedding, cloth and blankets.

### CROSS-REFERENCE TO RELATED APPLICATIONS

This application contains subject matter that is common to, and is a non-provisional application of, co-pending U.S. Provisional Patent Application Ser. No. 61/871,866, entitled “FLEXIBLE WEARABLE DEVICES HAVING EMBEDDED ACTUATORS PROVIDING MOTION STIMULATIONS”, filed Aug. 29, 2013, which application is incorporated by reference herein in its entirety. This application claims priority under 35 U.S.C. §119(e) as to common subject matter.

### STATEMENT REGARDING FEDERALLY SPONSORED RESEARCH OR DEVELOPMENT

This invention was made with government support under grant DMR-1120296 awarded by the National Science Foundation (NSF). The government has certain rights in the invention.

### TECHNICAL FIELD

This patent document relates to systems, devices, and processes that use mechanical actuators.

### BACKGROUND

The human body has many mechanoreceptors distributed near skin surface. Some of these mechanoreceptors, namely the Pacinian Corpuscles, are optimally resonant at 200-400 Hz tactile sensations.

### SUMMARY

Techniques, systems, and devices are disclosed for implementing actuator devices. These actuator devices that can be embedded in flexible and wearable apparel to provide motion stimulations, e.g., including mechanical perturbations tuned to biological mechanoreceptors of the skin.

In one aspect, a device to provide mechanical stimulation to a user includes an apparel material capable of being worn by a user, a flexible material substrate configured at a portion or region of the apparel material, an actuator module attached to the flexible material substrate and structured to include an array of piezoelectric actuators to apply mechanical perturbations at a frequency to the user wearing the apparel material, and a power supply module electrically coupled to the actuator module to provide electrical power to the actuator module.

The subject matter described in this patent document and attached appendices can be implemented in specific ways that provide one or more of the following features. For example, in some implementations, the disclosed technology includes use of the actuator module may be located within seats, pillows, or fabric items. The actuator module may include an array of actuators such as piezoelectric and/or electromagnetic actuators to create mechanical sensation onto the skin of a user. The disclosed technology also includes a flexible, wearable, and portable (e.g., battery-powered) device. The wearable device may be configured as a ‘massage vest’ or massage yoke which includes an array of piezoelectric and electromagnetic actuators to create mechanical sensation onto skin. The exemplary actuators can produce contact through an array of pins that create the sensation of finger tips caressing the skin directly or through clothing. The exemplary actuators can also be actuated at ultrasonic frequencies to drive mechanical sensation deep into tissue below skin for ultrasonic therapy. The exemplary actuator arrays can be actuated in patterns determined by the user or in present patterns through a microcontroller driver.

### BRIEF DESCRIPTION OF THE DRAWINGS

FIG. 1A shows an image of an exemplary sonic de-stressor device of the disclosed technology.

FIGS. 1B and 1C show diagrams of exemplary piezoelectric actuator to apply mechanical stimulation.

FIG. 2 shows an image depicting an exemplary configuration of the functional module including the mechanical actuators.

FIG. 3A shows a front view of an exemplary vest configuration of the apparel of the disclosed device worn by a user.

FIG. 3B shows a back view of an exemplary vest configuration of the apparel of the disclosed device worn by a user.

FIG. 3C shows a front view of an exemplary yoke configuration of the apparel of the disclosed device worn by a user.

FIG. 3D shows a back view of an exemplary yoke configuration of the apparel of the disclosed device worn by a user.

FIG. 4 shows a perspective view of another an exemplary vest configuration of the apparel of the disclosed device worn by a user.

FIG. 5 shows a schematic diagram of an array of actuators of the invention for use with an infant.

### DETAILED DESCRIPTION

Techniques, systems, and devices are disclosed for implementing actuator devices to provide motion stimulations, e.g., including mechanical perturbations tuned to biological mechanoreceptors of the skin, wherein these actuator devices may be embedded in items that touch people, flexible fabrics and wearable apparel.

In some implementations, a wearable, sonic de-stressing device is configured as a vest or yoke providing functional apparel that acts as an ultra-low power de-stressing device by mimicking the soothing effects of mother's touch to reduce serum cortisol levels. Elevated cortisol levels have been linked to a host of serious health problems including hypertension, heart disease, depression, emotional and physical stress, suppression of humoral immune and digestive function, and immune system compromise; these conditions are particularly problematic for individuals who already have risk factors for cardiovascular or immune diseases.

The device may include a network of piezoelectric cells and cell-phone vibration motors. The network may be embedded in furniture, fabrics or wearable apparel, like a vest which makes the device wearable and portable. For example, in the exemplary vest configuration, the functional module can be used to stimulate the upper back and shoulders, applying mechanical, shear, and ultrasonic forces to massage the skin with different, user-controlled patterns.

The disclosed technology may be used for sonic de-stressing and can be implemented in devices having modular designs. For example, functional actuator modules, e.g., including both actuators and vibrating motors, can be easily mounted and detached to the apparel module (e.g., vest, pants, etc. on a human or other animal, as well as in a blanket configuration), which can allow for easy laundry use and/or replacement as needed. The disclosed sonic de-stressing technology can be implemented in devices including combinations of stretchy and non-stretchy materials. For example, in some wearable implementations, placement of stretch-capable materials can include in side seams, shoulders and center back. This can allow for comfortable body motion and good fit on a wide range of sizes, as well as can ensure an optimal level of compression upon the user, which can enhance massage effect.

The disclosed sonic de-stressing technology can be implemented in devices including neoprene on top of the functional modules, e.g., which can minimize noise from the exemplary vibrator and avoid uncomfortable pressure and chaffing on the skin.

The human body has many mechanoreceptors distributed near skin surface. Some of these mechanoreceptors, namely the Pacinian Corpuscles, are optimally resonant at 200-400 Hz tactile sensations. In order to maximize the sensation to skin, the disclosed technology includes mechanical actuators to actuate skin surface at substantially the same frequencies at which the body mechanoreceptors are maximally receptive. This enables the use of very small amount of tactile energy to cause a sensation, e.g., very much like a finger caressing the skin.

In some aspects, an exemplary device includes these exemplary mechanical actuators to actuate at 200-400 Hz frequency ranged tuned to bodies own mechanical receptors. The exemplary device can be implemented using a low amount of electrical power. The low amount of electrical power needed to drive the actuators would lead to battery powered operation with significant operation time on one battery recharge.

In some implementations, the mechanical actuators can be piezoelectric actuators such as unimorphs and/or bimorphs onto which a series of tips are attached. These tips can touch the skin or fabric, upholstery or clothing attached to skin. The exemplary bimorphs, when driven by voltages, move the tips to impact the user periodically.

For example, if the tips are in contact with the skin already, then the periodic motion leads to periodic force onto skin. The tips can be made of plastic or other material. The tips may be geometrically configured to help reduce the risk of causing pain when in contact with skin and to maximizing the sensation to skin. In one geometric configuration, the tips are rounded. In some implementations, the tips can be placed such that they are at an angle, leading to application of force at an angle onto skin, creating a shear sensation. Also, the actuators and/or the tips can be formed in arrays to realize geometric configurations for reduced sharp force application on the user. For example, the actuator tips can be placed in an array with spacing corresponding to the spacing between naturally occurring grooves on finger tips. This spacing would lead to a natural touch sensation onto skin. Actuators in the actuator module may be arranged in an array, such as a pattern which mimics a human hand.

As another example, in the case of piezoelectric actuators, unimorphs and/or bimorphs can be driven at ultrasonic frequencies that generate waves transduced into skin that penetrate deep into tissue. For example, these vibrations can be used to heal damaged tissue by increased temperature and circulation as often done with high frequency ultrasonic therapy. In some implementations, for example, both soft touch at 200-400 Hz and ultrasonic actuation can be implemented to provide surface sensation and deep body sensation. In some implementations, for example, the actuators can also be made of miniature electromagnetic motors that have an off-shifted mass to create a sensation of vibration on skin surface. For example, these exemplary actuators can be configured similar to the vibration motors found in cell phones.

In some implementations, for example, the actuators can also be electromagnetic plunger type actuators made of a coil and permanent magnet. In some implementations, for example, the array of the actuators can be placed spatially into the vest, and switched on and off with variable duty cycles to create a sensation of a hand touching the skin. The exemplary actuators can be mounted onto the vest through an assembly that allows the person to flex the back, or sit with the back against another surface, and still have the actuators in contact with the skin or clothing. In some implementations, for example, the array of actuators can be driven by a PC board consisting of a microcontroller and a battery and is able to communicate to a remote control or a computer by wired and wireless interface. The controller board is mounted into the vest with the actuator array. In some examples, a user of the exemplary device can be able to program the pattern of actuator actuation on a computer program, or select from preprogrammed actuators.

In some aspects, the disclosed devices can be configured as a functional apparel that acts as an ultra-low power de-stressing device by mimicking the soothing effects of mother's touch to reduce activators of biological stress systems. For example, when the Central Nervous System interprets external stimuli as potentially harmful, it involves the Sympathetic Nervous System and Endocrine System to respond to them, resulting in a “Fight or Flight” response. During this response, the sympathetic nerves release norepinephrine, a stress hormone that causes short term symptoms such as increased heart rate and blood pressure, sweating, and dilated pupils. Prolonged activation of the Sympathetic Nervous System suppresses major body system functions such as beneficial cell-mediated immune responses. Prolonged chronic release has been linked to a host of serious health problems including hypertension, heart disease, depression, and immune system compromise; these conditions are particularly problematic for individuals who already have risk factors for cardiovascular or immune diseases. Prolonged chronic release has also been implicated in causing obesity and aging. Soothing stimuli initiate parasympathetic responses and counteract Fight or Flight responses.

An exemplary sonic de-stressor device can be structured include a network of piezoelectric cells and cell-phone vibration motors that are built into a vest apparel substrate material, e.g., making the device wearable and portable. The functional module of the exemplary device stimulates the upper back and shoulders, applying mechanical, shear, and ultrasonic forces to massage the skin with different, user-controlled patterns. The piezoelectric cells can vibrate at a frequency ranging from 100-300 Hz, which is the frequency to which nerves are most sensitive.

The exemplary sonic de-stressor device can be used to reduce stress on a physiological and chemical level. Additionally, for example, commercial massagers consume lots of power and cannot be used all day, whereas the disclosed devices can be implemented using extremely low power, and in some implementations, the disclosed devices can last on a single 5V battery for several days. For example, the whole electric circuit can be operated to use single 5V power supply charged by any USB connection, so the user can power a device with a computer or tablet.

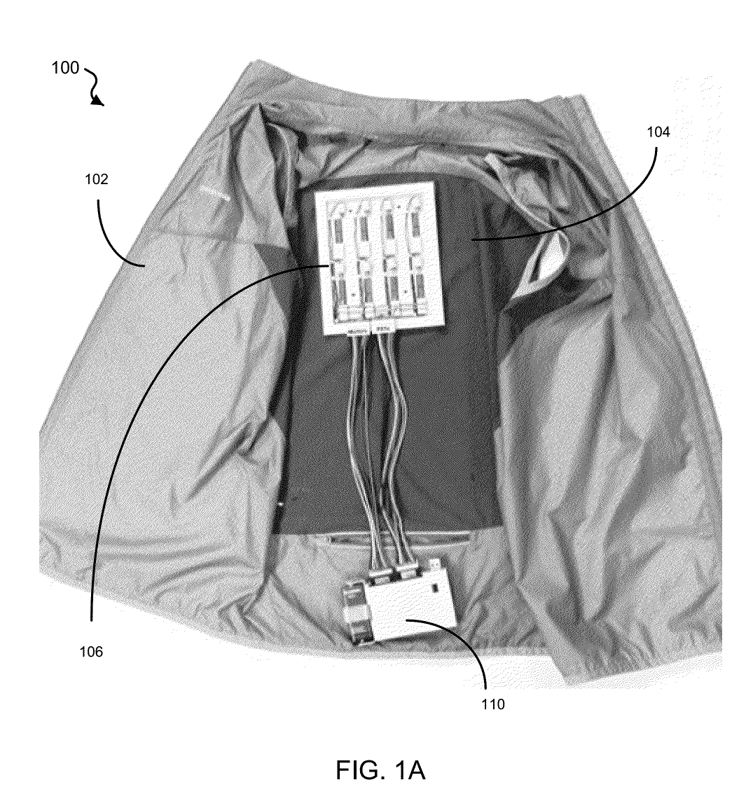

FIG. 1A shows an image of an exemplary flexible wearable de-stressor device 100 of the disclosed technology. The device 100 includes a wearable apparel material 102 (e.g., a vest, yoke, coat, pants, hat, glove or other clothing, cloth or blanket, etc.). The wearable apparel material 102 includes a flexible material substrate 104 configured at a portion or region of the wearable apparel material 102 to where mechanical stimulations are to be applied to a user wearing the device 100. For example, as shown in the example of FIG. 1A, the flexible material substrate 104 is configured on the backside of the wearable apparel material 102. The device 100 includes one or more functional actuator module 106 including one or more mechanical actuators 108. As shown, the mechanical actuators 108 may be placed in an array on a side of the functional actuator module 106. One or more vibrating motors may be placed within or on the functional actuator module 106 along with the mechanical actuators 108.

In alternative embodiments, the actuator module 106 may be located within furniture, such as seating, or a bed, or within a home accessory, such as a pillow or stuffed animal, sites from which soothing stimuli can be detected by the infant's nervous system

A power supply 110 connected to the functional module 106 may also be provided so that the device 100 may be operational and portable. In addition one or more controllers and/or communications modules for the functional module 106 may be attached to the functional module 106. The controllers and/or communications modules may be configured with or on the power supply 110. The power supply 110 may be an ultra low power module, comprising a microcontroller such as a TI cc25x0 microcontroller. The power module 110 may also include a Bluetooth receiver module for remote control and activation.

A combination of different types of mechanical actuators 108 may be used in the functional module 106, including vibrating motors, selectively or in combination, including one or more vibrating motors, piezoelectric actuators providing ultrasonic stimulation and/or mechanical stimulation and mechanical brush movement. The ultrasonic stimulation may be provided at approximately 140 mW. The vibrating motor may be a cell phone motor set to provide mechanical stimulation at approximately 1 W. The functional module may be made of plastic, and printed from a 3D printer. With its low power requirements, the device may be used for approximately 2 weeks using a 2200Ah lithium battery.

In one embodiment, the actuator or actuators 108 may be one or more piezoelectric unimorphs or bimorphs. FIGS. 1B and 1C show diagrams of an exemplary piezoelectric bimorph actuator 112 of the functional module 106 for the application of stimulation to a user. As shown, a piezoelectric bimorph actuator 112 may have on it a tip 114 or series of tips are attached such that the tip 114 or tips apply pressure to the skin 116 of the user or apparel over the skin of the user. For example, the mechanical actuators 108 of the functional module 106 can be implemented to actuate at any number of frequency ranges, including the 200-400 Hz frequency range which would be tuned to a human body's own mechanical receptors, providing mechanical motion and stimulations upon the user.

As shown in FIG. 1B, the exemplary piezoelectric actuator 112 may include high aspect ratio pillars 118, e.g., which may move by modulation of high frequency with low-frequency resonant action. For example, as shown in FIG. 1C, the piezoelectric actuator 112 can be used to apply motion to move one or more high aspect ratio pillars 118 at an angle to create shear motion on skin or whatever is contacting a contact end 120 of the high aspect ratio pillars 118. These pillars 118 may be made of plastic and created from a 3D printer. The piezoelectric actuators 112 may be arranged in arrays. Also, the actuators may be actuated at a low frequency, such as 100-300 Hz sweeping frequency. As shown, the mechanical actuators themselves may be arranged in an array within the functional module.

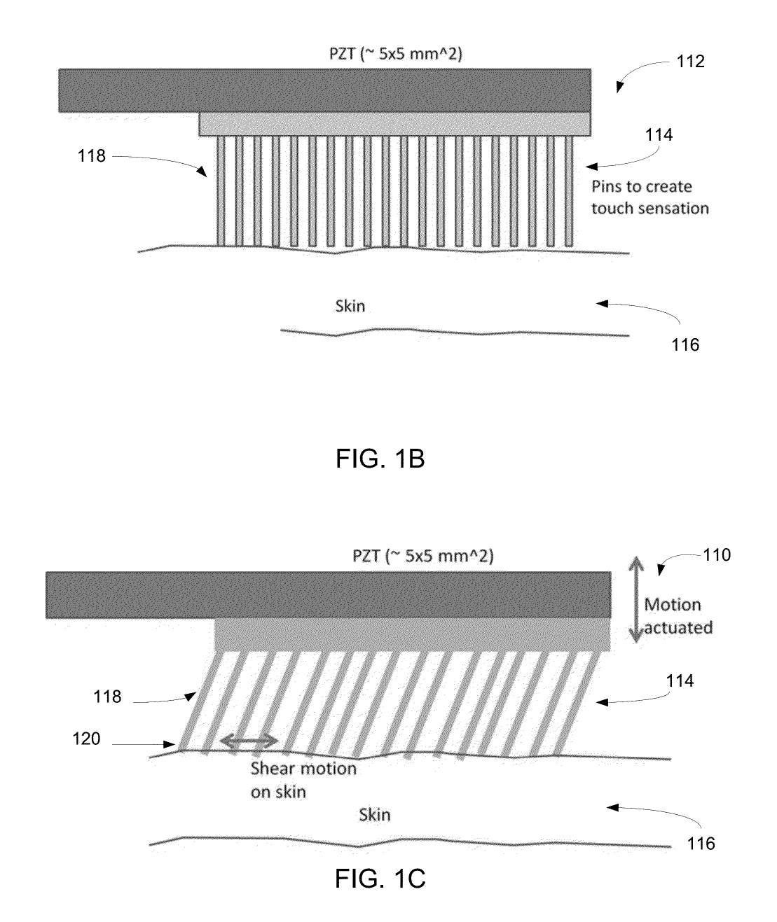

FIG. 2 shows an image depicting an exemplary configuration of the functional module 106 including the mechanical actuators 108. As shown, the mechanical actuators 108 are arranged in an array.

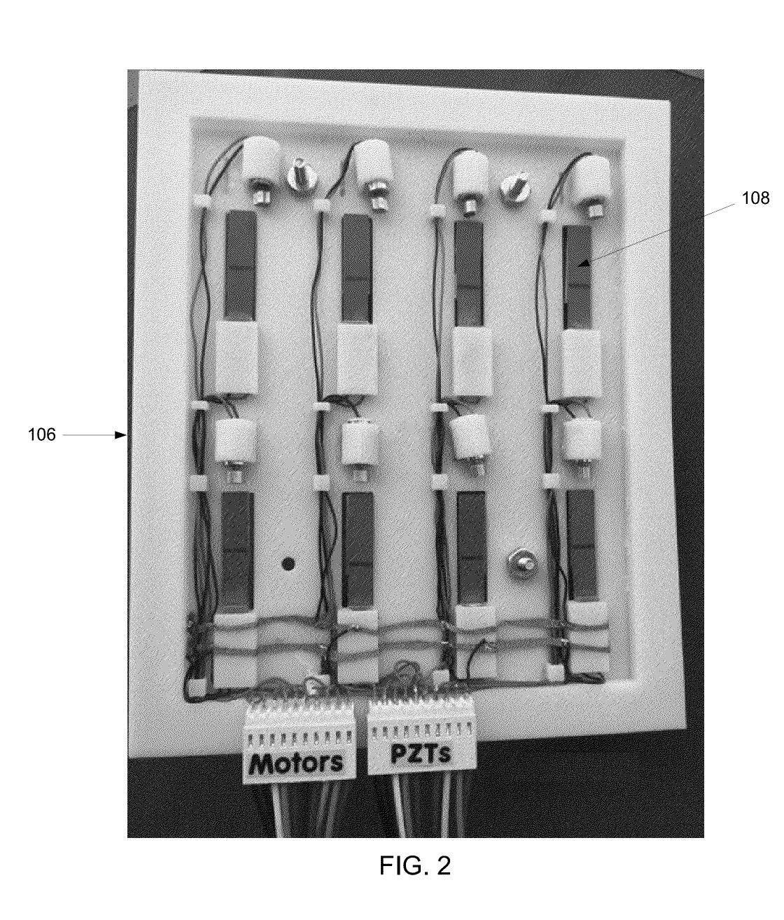

FIGS. 3A and 3B illustrate another exemplary configuration of the apparel 102 of the disclosed device 100 as worn by a user. As shown, the apparel 102 may configured as a vest 122. As shown, elements such as the side elements 124, shoulder elements 126 and center back element 128 may be made of a stretchable material, such as Spandex, so that the apparel 102 best fits the user. A closable seam 130 may be included to make wearing the vest easier. The closable seam may use a material such as Velcro for closing.

FIGS. 3C and 3D show images of an exemplary yoke 132. The yoke 132 may contain and hide the actuator module. The yoke 132 may have shoulder elements and a center back element made of stretchable material like the configuration of the vest 122.

The apparel material may be designed to hold the added weight of the actuator module. In one embodiment, the apparel would include elements such as interfacing between the functional module and the user and multiple layered seams, which would also reinforce the structure of the entire garment. Also, neoprene may be used as a material for the apparel to avoid chafing or uncomfortable pressure. Also, the weight of the modules in the device should have symmetric weight distribution to make it easier for the user to wear. The apparel may be worn with a snug fit to maximize the effect of the actuators on the user and to minimize any gaps between the user and clothing worn outside of the apparel.

The actuator module also may be modular in design so that the device may be repaired or modified easily.

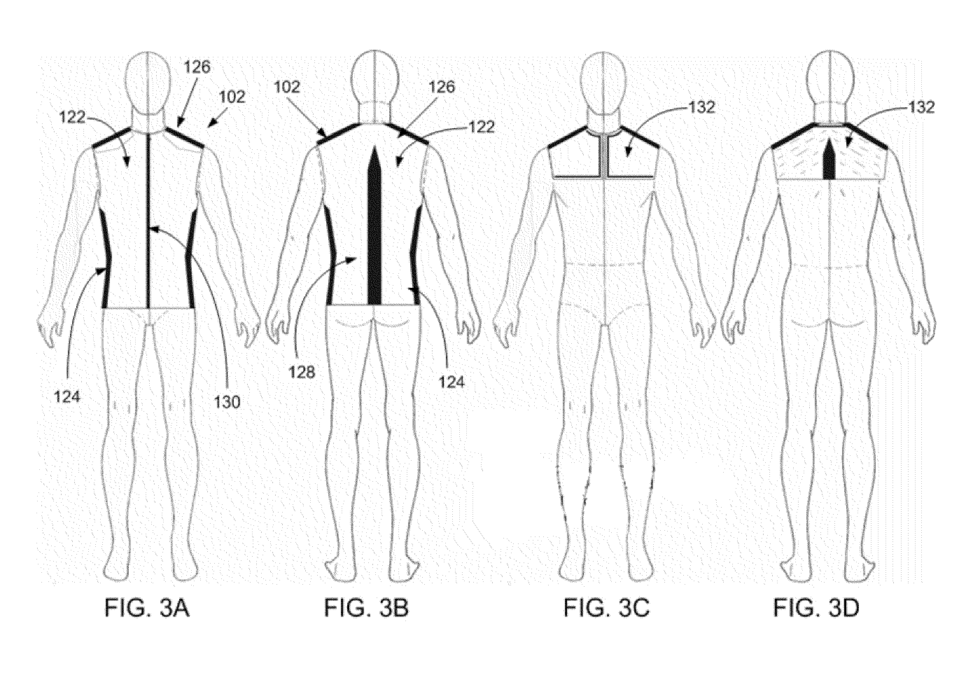

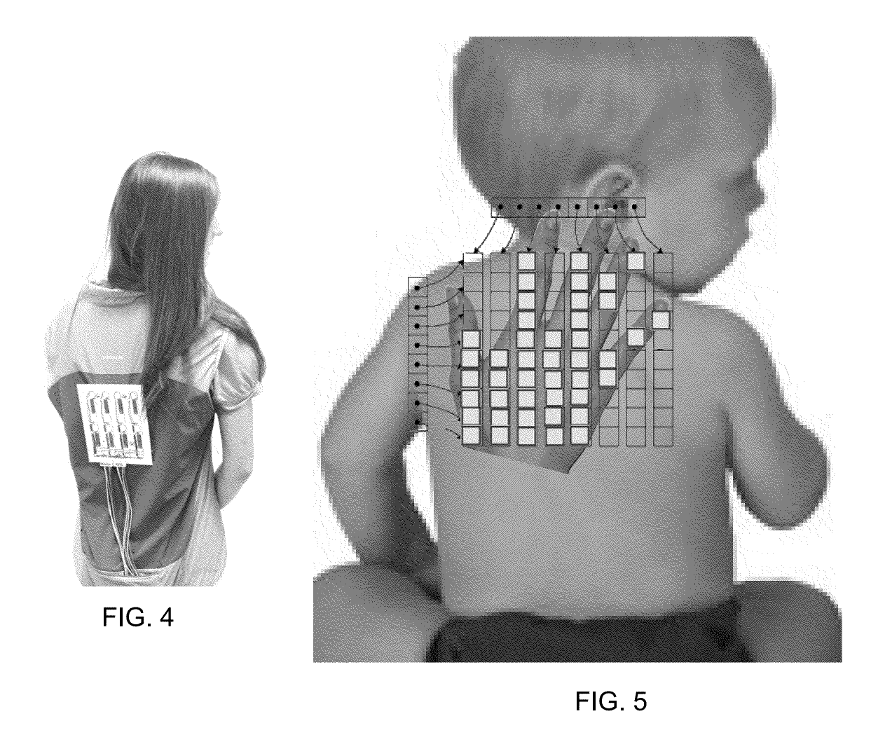

FIG. 4 illustrates the apparel worn by a user. FIG. 5 illustrates one configuration of an array of mechanical actuators for the invention such that the touch from the array of mechanical actuators mimics a mother's touch.

The disclosed device 100 may be implemented using extremely low power, and for example, in some implementations, the disclosed devices can last on a single 5V battery for a week. For example, the whole electric circuit can be operated to use single 5V power supply charged by any USB connection, so the user can power the device 100 with a computer or tablet.

Some examples of the material design and fiber properties for the invention are disclosed in Appendix A which is included as part of the disclosure of this patent document in their entirety. Relevant data regarding vibration sensitivity is disclosed in Appendix B which is included as part of the disclosure of this patent document in their entirety.

The disclosed de-stressing devices, systems, and techniques can be implemented in a variety of health care applications. This technology can apply to both personal comfort and home health as well as for medical purposes. For example, the disclosed technology can be used by anyone who encounters stress in their everyday lives, e.g., from office workers to professional athletes. For example, the disclosed technology can be a useful tool in individuals with preexisting conditions that leave them immune system compromised, e.g., like cancer or HIV, among others.

While this patent document and attached appendices contain many specifics, these should not be construed as limitations on the scope of any invention or of what may be claimed, but rather as descriptions of features that may be specific to particular embodiments of particular inventions. Certain features that are described in this patent document and attached appendices in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document and attached appendices should not be understood as requiring such separation in all embodiments.

Only a few implementations and examples are described and other implementations, enhancements and variations can be made based on what is described and illustrated in this patent document and attached appendices.

What is claimed are techniques and structures as described and shown, including:

1. A flexible wearable device to provide mechanical stimulation to a user, comprising:
an apparel material capable of being worn by a user;
a flexible material substrate configured at a portion or region of the apparel material; and
an actuator module attached to the flexible material substrate and structured to include one or more piezoelectric actuators to apply mechanical perturbations at a frequency to the user wearing the apparel material.

2. The device as in claim 1, wherein the apparel material includes at least one of a vest, yoke, coat, pants, hat, glove, cloth or blanket.

3. The device as in claim 1, further comprising a power supply module electrically coupled to the actuator module.

4. The device as in claim 2, wherein the flexible material substrate is configured on a backside of the apparel material to apply the mechanical perturbations to the body of the user.

5. The device as in claim 1, wherein the piezoelectric actuators are bimorph actuators, wherein at least one bimorph actuators includes a tip protruding from the piezoelectric actuator such that the tip touches at least one of one of the skin of the user and the clothing attached to skin of the user.

6. The device as in claim 1, wherein the frequency of the piezoelectric actuator is approximately 200-400 Hz.

7. The device as in claim 1, further comprising:
a controller unit including
a processor, and
a memory coupled to the processor to store data,
the controller unit configured to provide control signals to the actuator module.

8. The device as in claim 7, further comprising:
a transmitter and receiver communication unit communicatively coupled to the controller unit to provide remote communication of the data to another computer device.

9. An actuator device, comprising:
an actuator housing,
a mechanical actuator, including at least one of vibrating motors, piezoelectric actuators providing ultrasonic stimulation piezoelectric actuators providing mechanical stimulation and mechanical brush actuators located on the housing,
wherein movement of one or more mechanical actuators is configured to apply mechanical perturbations at a frequency of approximately 100-400 Hz, and
wherein the piezoelectric actuator includes one or more tips configured to apply a predetermined pressure over a predetermined area, and
wherein the tips are configured in a predetermined tip configuration.

10. The device of claim 9, wherein the piezoelectric actuators are piezoelectric bimorph actuators.

11. The device of claim 10, further comprising vibrating motors located on the housing.

12. The device of claim 9, wherein the tips are offset.

13. The device of claim 9, wherein the actuator module is located within one of a pillow, seat, bed and stuffed animal.

14. The device of claim 9, wherein the actuator module is in physical connection with one of wearable apparel, bedding, cloth and blankets.

15. A method of de-stressing, comprising the steps of:
providing a flexible wearable device to provide mechanical stimulation to a user, comprising:
an actuator module attached to a flexible material substrate and structured to include one or more piezoelectric actuators to apply mechanical perturbations at a predetermined frequency to the user wearing the apparel material, and
activating the device.
